(19) United States
(12) Patent Application Publication
(10) Pub. No.: US 2014/0165829 A1
(43) Pub. Date: Jun. 19, 2014

(54) FUEL GAS CONDITIONING USING MEMBRANE SEPARATION ASSEMBLIES

(71) Applicant: UOP LLC, Des Plaines, IL (US)

(72) Inventors: Bhargav Sharma, Niles, IL (US); Cody Nolen, Denver, CO (US)

(73) Assignee: UOP LLC, Des Plaines, IL (US)

(21) Appl. No.: 13/715,802

(22) Filed: Dec. 14, 2012

(51) Int. Cl. B01D 53/22

(52) U.S. Cl. CPC B01D 53/22
USPC 95/50

(57) ABSTRACT

A method for conditioning natural gas into a fuel gas suitable for use as fuel to an engine includes delivering a natural gas stream to a membrane separator. The natural gas stream has a heating value greater than or equal to about 1.15×10⁶ Joules (about 1100 BTU). The method further includes separating the natural gas stream in the membrane separator into a residue stream and a permeate stream. The residue stream includes C₂+ hydrocarbons at a concentration greater than a concentration of C₂+ hydrocarbons in the natural gas stream, and the permeate stream includes methane at a concentration greater than a concentration of methane in the natural gas stream. Still further, the method includes delivering the permeate stream to an engine for use as fuel gas to the engine.

### TECHNICAL FIELD

The present disclosure relates to fuel gas conditioning. More particularly, the present disclosure relates to methods for removing C₂+ hydrocarbons from a fuel gas stream to reduce the heating value of the fuel gas stream using glassy polymer-based membranes.

### BACKGROUND

Shale gas is natural gas formed when trapped within shale formations. Shale gas has become an increasingly important source of natural gas in the United States since the start of this century, and interest has spread to potential gas shales in the rest of the world. In the year 2000, shale gas provided less than 1% of worldwide natural gas production; by 2010, it was over 10%.

As demand for shale gas increases, shale gas sources now are sought in remote locations with little established gas processing and transportation infrastructure. One such form of infrastructure is the compressor. Compressors function to increase the pressure of the shale gas to facilitate its transportation through a network of pipelines from the shale source to its end market. Further, some shale applications require compression equipment to assist producers in removing potential liquids (water, heavier hydrocarbons, etc.) from the shale gas, as well as to provide fuel for the compression systems and other fuel gas users such as stabilizers, line heaters, and dehydration equipment.

The shale oil boom has created the need for thousands of new compressors to be installed in remote areas. The engines of such compressors, which are typically reciprocating engines, are designed to handle fuel gas with a heating value of around 1.05×10⁶ Joules (about 1000 BTU). However, many times the only fuel gas that is readily available in such remote areas is shale gas itself, with relatively high BTU heating values due to its high C₂+ content, for example around 1.35×10⁶ Joules (about 1300 BTU) and higher.

There are a number of challenges and a range of compressor engine dynamics associated with burning the variety of gases produced in shales and other sources yielding high heating values, as well as equipment alternatives for conditioning the gas produced in the field to enhance its quality as a fuel for compressor engines and other production equipment. Using high heating value shale gases as a fuel source for these reciprocating engine-driven compressors affects the dynamics of performance. With this high heating value gas as fuel, most larger-horsepower compressor engines are subject to a substantial derating. High levels of heavy (C₂+) hydrocarbon components lead to reciprocating gas engines pre-detonating, which requires derating the engines so they can maintain safe air-to-fuel ratio levels. In other words, the available horsepower is reduced, leaving less horsepower for the process usage, such as compression.

Furthermore, this high heating value shale gas is detrimental for the compressor engines because it burns hotter and forms carbon deposits that cause premature breakdown of the engine. Heavy hydrocarbon-rich gas can damage or foul engine components, causing mechanical reliability issues and reduced compressor/engine efficiencies, possibly leading to an engine shutdown, which has an immediate negative impact on production flow until the damaged components are replaced or repaired. Engine life is suggested to be half or less of the typical expected lifecycle when high heating value fuel gas is used. These engines are very large and costly, and hence it is desirable to deliver fuel gas at the heating value for which the compressors were designed in order to extend the life of the engines, especially in such remote areas.

Accordingly, it is desirable to provide methods for removing heaving hydrocarbons from natural gas to form fuel gas. These and other desirable features and characteristics will become apparent from the subsequent detailed description and the appended claims, taken in conjunction with the accompanying drawings and the foregoing technical field and background.

### BRIEF SUMMARY

Methods for fuel conditioning are provided herein. In an exemplary embodiment, a method for conditioning natural gas into a fuel gas suitable for use as fuel to an engine includes delivering a natural gas stream to a membrane separator. The natural gas stream has a heating value greater than or equal to about 1.15×10⁶ Joules (about 1100 BTU). The method further includes separating the natural gas stream in the membrane separator into a residue stream and a permeate stream. The residue stream includes C₂+ hydrocarbons at a concentration greater than a concentration of C₂+ hydrocarbons in the natural gas stream, and the permeate stream includes methane at a concentration greater than a concentration of methane in the natural gas stream. Still further, the method includes delivering the permeate stream to an engine for use as fuel gas to the engine.

In another exemplary embodiment, a method for conditioning natural gas into a fuel gas suitable for use a fuel to a compressor engine includes compressing a shale natural gas stream to a pressure of about 6.9×10⁶ Pa (about 1000 psi) or greater. The shale natural gas stream has a heating value greater than or equal to about 1.25×10⁶ Joules (about 1200 BTU). The method further includes passing the shale natural gas to a filter coalescer after compressing the natural gas, passing the shale natural gas to a membrane pre-heater after passing the natural gas to the filter coalescer, passing the shale natural gas to guard bed after passing the natural gas to the membrane pre-heater, passing the shale natural has to a particle filter after passing the natural gas to the guard bed, and delivering a shale natural gas stream to a glassy polymer cellulose acetate membrane separator. Still further, the method includes separating the shale natural gas stream in the membrane separator into a residue stream and a permeate stream. The residue stream includes C₂+ hydrocarbons at a concentration greater than a concentration of C₂+ hydrocarbons in the shale natural gas stream, and the permeate stream includes methane at a concentration greater than a concentration of methane in the natural gas stream and has a heating value of less than or equal to about 1.05×10⁶ Joules (about 1000 BTU). Still further, the method includes delivering the permeate stream to a compressor engine for use as fuel gas to the compressor engine.

### BRIEF DESCRIPTION OF THE DRAWINGS

The various embodiments will hereinafter be described in conjunction with the following drawing figures, wherein like numerals denote like elements, and wherein:

FIG. 1 is a system suitable for use in a fuel gas conditioning method in accordance with an embodiment of the present disclosure;

FIG. 2 is a schematic illustration of a membrane element arrangement suitable for use with an embodiment of the present disclosure; and

FIG. 3 is a schematic illustration of a membrane element arrangement suitable for use with another embodiment of the present disclosure.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

The present disclosure describes use of membrane separation technologies to condition, i.e., reduce the heating value of, fuel gas for operating compressor engines in natural gas processing and transportation applications. For fuel gas conditioning, it is desirable to remove heavier hydrocarbons from the raw natural gas stream to reduce the heating value of the natural gas for use as fuel. As used herein, “heavier” hydrocarbons means hydrocarbons having two or more carbons, designated herein as “C₂+”, or three or more carbons, designated herein as “C₃+”.

In an exemplary embodiment, a natural gas stream is conditioned into a fuel gas suitable for use as fuel to an engine. The natural gas stream initially (i.e., prior to conditioning) has a heating value greater than or equal to about 1.15×10⁶ Joules (about 1100 BTU). The natural gas stream is delivered to a membrane separation assembly, wherein the membrane assembly separates the natural gas stream into a residue stream and a permeate stream. The residue stream includes C₂+ or C₃+ hydrocarbons at a concentration greater than a concentration of C₂+ C₃+ hydrocarbons in the initial natural gas stream, and the permeate stream includes methane at a concentration greater than a concentration of methane in the initial natural gas stream. The conditioned natural gas in the permeate stream has a heating value of less than or equal to about 1.05×10⁶ Joules (about 1000 BTU). Thereafter, the conditioned natural gas in the permeate stream is delivered to an engine for use as fuel gas to the engine.

A variety of known commercial processes rely on the use of fluid separation techniques in order to separate one or more desirable fluid components from a mixture. In particular, various such processes may involve the separation of liquid mixtures, the separation of vapors or gases from liquids, or the separation of intermingled gases. For example, in the production of natural gas, it is typically necessary for the producer to remove carbon dioxide, hydrogen sulfide, helium, water and nitrogen from natural gas in order to meet both government and industrial regulatory requirements. It is also typically desirable in many chemical processes for hydrogen to be removed and recovered from gaseous process streams. In these prior art processes, however, the permeate stream that contains the carbon dioxide, hydrogen sulfide, helium, etc. is discarded (or withdrawn to other systems for further separation), leaving the residue (non-permeate) stream as the product stream. Embodiments of the present disclosure, in contrast, use the fact that the permeate stream can be “tuned” to also include a relatively higher concentration of light hydrocarbons (e.g., methane), thereby using the permeate stream as the desired product stream for use as fuel gas for powering, for example, compressor engines.

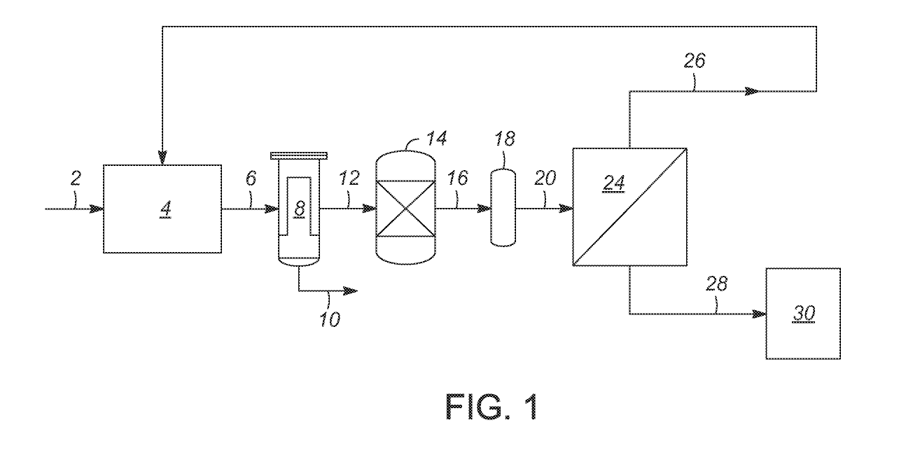

FIG. 1 illustrates an exemplary system suitable for use in a fuel gas conditioning method in accordance with an embodiment of the present disclosure. As shown in FIG. 1, a feed source 2 of natural gas is provided to a compressor unit 4. The feed gas 2, in an exemplary implementation, is a typical wellhead gas stream as results from shale gas extraction operations. Typical shale wellhead gas mixtures primarily include methane, with some amounts of C₂-C₆ (and higher) hydrocarbons, nitrogen, carbon dioxide, hydrogen sulfide, and water.

As noted above, the compressor unit 4 functions to increase the pressure of the shale gas to facilitate its transportation through a network of pipelines from the shale source to further processing stages. Further, some shale applications require compression equipment to assist producers in removing potential liquids, as well as to provide fuel for the compression systems and other fuel gas users such as stabilizers, line heaters, and dehydration equipment. In compressor unit 4, the feed gas is first compressed to a pressure of about 5.5×10⁶ Pa (about 800 psi) to about 8.3×10⁶ Pa (about 1200 psi), for example about 6.9×10⁶ Pa (about 1000 psi), and then cooled to a temperature of about 38° C. (about 100° F.) to about 60° C. (about 140° F.), for example about 49° C. (about 120° F.), before entering a pretreatment system via stream 6, which is typically required upstream of membrane separators.

The pretreatment system can include, for example, filter coalescer 8, guard bed 14, and particle filter 18. Further, a pre-heater may optionally be included. The filter coalescer 8 may be employed to remove any aerosol liquid components (including heavier hydrocarbons and/or entrained lube oil from compressor) or gaseous water (referred to as “mist”) that may be present in the natural gas stream. Exemplary gas/liquid filter coalescers are known in the art, having efficiencies that are typically greater than or equal to about 99.98%. The liquids and mist exits filter coalescer 8 via stream 10, with the fuel gas continuing through the pre-treatment system via stream 12.

The guard bed 14, which in an embodiment is a non-regenerative activated carbon guard bed, functions to remove any contaminants, such as lube oil, from the gas stream, such as may have been introduced from the pipeline, compressor, and/or other external sources. The decontaminated fuel gas flows from the guard bed 14 via stream 16, whereafter it is introduced into particle filter 18. Particle filter 18 functions to remove fine particles from the fuel gas that might have been entrained from the upstream activated carbon guard bed 14. The filtered fuel gas thereafter exits the pre-treatment system and travels via stream 20 to membrane separator 24. If included, the optional pre-heater provides heat to raise the temperature of the natural gas stream to a desired operating temperature for introduction into the membrane separator (such temperature being determined by the particular type of separator employed, as is known in the art).

Reference will now be made to the membrane separator 24. The use of membranes for fluid separation processes has achieved increased popularity over other known separation techniques. Such membrane separations are generally based on relative permeabilities of various components of the fluid mixture, resulting from a gradient of driving forces, such as pressure, partial pressure, concentration, and/or temperature. Such selective permeation results in the separation of the fluid mixture into portions commonly referred to as “residual” or “retentate”, e.g., generally composed of components that permeate more slowly; and “permeate”, e.g., generally composed of components that permeate more quickly.

Membranes for gas processing typically operate in a continuous manner, wherein a feed gas stream is introduced to the membrane gas separation module on a non-permeate side of a membrane. The feed gas is introduced at separation conditions which include a separation pressure and temperature that retains the components of the feed gas stream in the vapor phase, well above the dew point of the gas stream, or the temperature and pressure condition at which condensation of one of the components might occur.

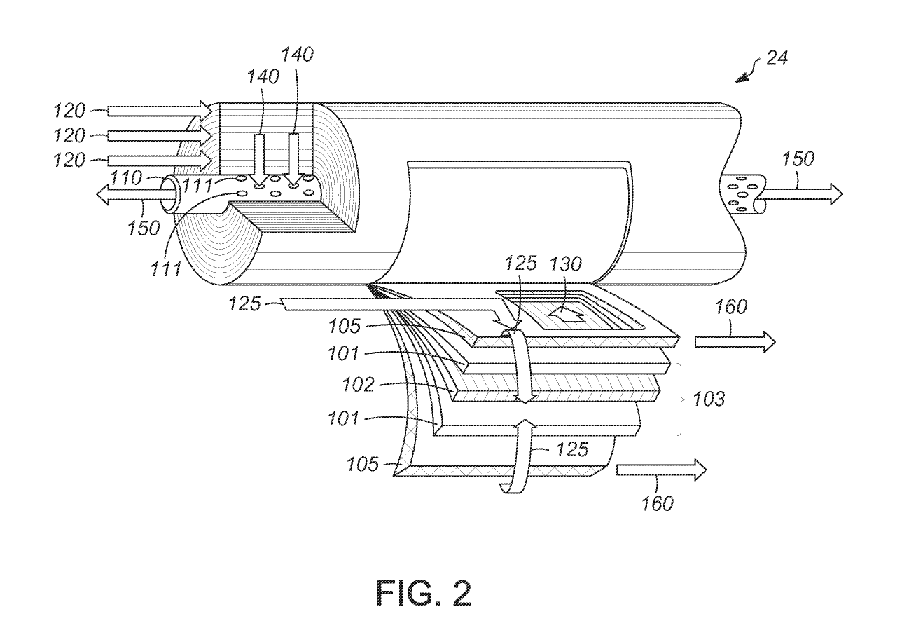

Separation membranes are commonly manufactured in a variety of forms, including flat-sheet arrangements and hollow-fiber arrangements, among others. In an exemplary embodiment of the present disclosure, referring now to FIG. 2, a flat-sheet separation membrane is employed as separation membrane 24. In a flat-sheet arrangement, the sheets are typically combined into a spiral wound element. An exemplary flat-sheet, spiral-wound membrane element 24, as depicted in FIG. 2, includes two or more flat sheets of membrane 101 with a permeate spacer 102 in between that are joined, e.g., glued along three of their sides to form an envelope 103, i.e., a “leaf”, that is open at one end. The envelopes can be separated by feed spacers 105 and wrapped around a mandrel or otherwise wrapped around a permeate tube 110 with the open ends of the envelopes facing the permeate tube. Feed gas 120 enters along one side of the membrane element and passes through the feed spacers 105 separating the envelopes 103. As the gas travels between the envelopes 103, highly permeable compounds permeate or migrate into the envelope 103, indicated by arrow 125. These permeated compounds have an available outlet: they travel within the envelope to the permeate tube 110, as indicated by arrow 130. The driving force for such transport is the partial pressure differential between the low permeate pressure and the high feed pressure. The permeated compounds enter the permeate tube 110, such as through holes 111 passing through the permeate tube 110, as indicated by arrows 140. The permeated compounds then travel through the permeate tube 110, as indicated by arrows 150, to join the permeated compounds from other membrane elements that may optionally be connected together in a multi-element assembly. Components of the feed gas 120 that do not permeate or migrate into the envelopes, i.e., the residual, leave the element through the side opposite the feed side, as indicated by arrows 160.

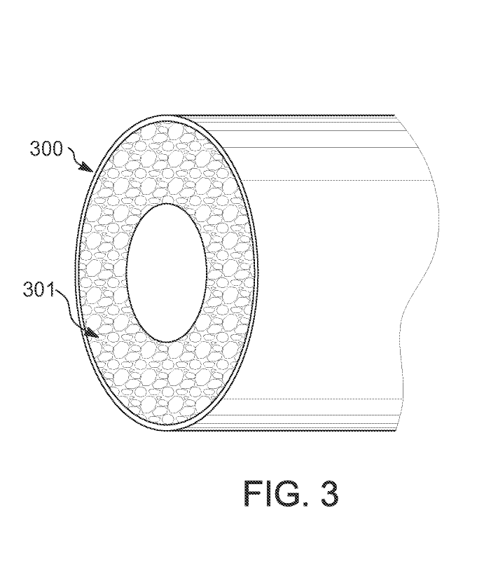

FIG. 3 depicts an alternative embodiment of a membrane suitable for use in the presently described gas treatment system. In particular, a hollow fiber membrane structure 300 is depicted. As is known in the art, the hollow fiber membrane structure 300 includes a plurality of hollow fibers 301 that selectively allow various gasses or liquids to permeate therethrough, depending on the design. The present disclosure, in alternative embodiments, may employ either the spiral-wound membranes noted above in FIG. 2, or the hollow fiber membranes shown in FIG. 3.

In an exemplary embodiment, whether the spiral-wound membrane 101 or hollow-fibers membrane 301 is employed, the membrane may be constructed of a glassy polymer material. In one example, the glassy polymer material can include cellulose acetate. In another embodiment, the glassy polymer material can include a polyimide, per-fluoro polymer-based material.

Returning to FIG. 1, after pretreatment, the gas enters the separation membrane 24 via line 20. The membrane 24 separates the gas into heavier hydrocarbon rich residue (non-permeate) stream 26 and lighter hydrocarbon rich permeate stream 28. The residue gas stream 26 can be recycled back to re-join the unconditioned natural gas stream. For example, in one embodiment, the residue stream 26 is delivered back to a compression inter-stage of the compressor 4 to comingle back with the feed source of natural gas (feed source 2 as it is compressed in the compressor 4).

As noted above, in an embodiment, the membranes are thin semi-permeable barriers that selectively separate some compounds from others based on solution-diffusion principal. The membranes separate gas stream based on how well different components dissolve and diffuse through it. In the presently described implementation, CO₂, H₂S and water permeates fast and will be concentrated in permeate gas. Moreover, lighter hydrocarbons will also permeate relatively faster compared to heavier hydrocarbons (C₂+ or C₃+), resulting in a residue stream much richer in heavier hydrocarbon. Hence, by controlling process parameters desired adjustment of heating value content can be achieved in permeate gas.

More particularly, it is possible to “tune” the heating value of the permeate gas by adjusting the temperature and pressure at which the membrane separator 24 operates. The temperature can be controlled by, for example, the pre-heater unit of the pre-treatment system. The pressure can be controlled by, for example, by a pressure control valve on the permeate stream. In some examples, increasing the operating temperature increases the overall diffusion rate in the membrane separator, and as such a greater concentration of lighter components will permeate into the permeate gas, resulting in a permeate gas with a lower heating value. Further, in some examples, increasing the operating pressure of the permeate stream, in contrast, slows the permeation rate of lighter components and will increase the heating value of the permeate stream.

Permeate gas, which exits the separator via line 28, is available at, for example, about 5.5×10⁵ Pa (about 80 psi) to about 1.0×10⁶ Pa (about 150 psi), such as about 6.9×10⁵ Pa (about 100 psi), and can be used as fuel directly for one or more components 30, such as compressor engines as described above. Component 30 can be a compressor engine, for example, or it can be any other components of the natural gas transportation and processing assembly that requires fuel gas. Furthermore, the permeate gas could also be directed back to the engine of compressor 4 to provide fuel to the engine of compressor 4.

As described above, when the membrane (e.g., membrane 101 or membrane 301) is exposed to hydrocarbon gas stream, lighter hydrocarbons will permeate relatively faster compared to heavier hydrocarbons (C₂+ or C₃+), resulting in a residue stream that is much richer in heavier hydrocarbon. Hence, by controlling process parameters, desired adjustment of heating value content of the gas stream can be achieved in permeate gas stream 28. For example, if an approximately 1.45×10⁶ Joules (about 1400 BTU) gas is run through the membrane separator 24, permeate stream 28 richer in methane (with a BTU content of about 1.05×10⁶ Joules (about 1000 BTU)) can be obtained.

As noted above, gas compression engines operate optimally with a majority of methane in the fuel stream because of the relatively lower carbon number content and the lower burning temperature. Since the required pressure in fuel gas compressors are in range of the operating pressure of the permeate gas line 28, no additional pressurization of fuel gas is required. As such, the heavier C₂+ hydrocarbons exits the membrane via the high pressure residue stream 26 while the lowered heating value fuel gas stream 28 exits on the low pressure side at, for example, about 6.9×10⁵ Pa (about 100 psi). There is no hydrocarbon loss in this system implementation since non-permeate gas is recycled back at appropriate stage of compression and pressure drops due the membrane are minimal.

The membrane housing structure, referred to as the “skid,” can be made using the conventional valving and housings as a typical gas membrane separation plant used in sour gas service, known in the art. The pretreatment system, including the coalescer, particle filter, guard bed, and heater is applied as necessary, and will depend on the characteristics of the feed gas source, as is known in the art. The permeate gas stream 28 will be used as fuel directly to the compressor engine, and other components. The inlet to the membrane can be modulated as well as the back-pressure on the membrane permeate flow in order to control and maintain a steady heating value to the compressor.

### EXAMPLE

The following example is provided to illustrate an embodiment of the present disclosure. The design basis for this example is a fuel gas stream shown in the material balance in the Table, which is a typical wellhead gas stream in shale gas found in the United States. Feed gas (stream 2, FIG. 1) is available at a temperature of about 15° C. (about 60° F.) to about 32° C. (about 90° F.) and a pressure of about 1.2×10⁶ Pa (about 170 psi). The feed gas is compressed to about 6.9×10⁶ Pa (about 1000 psi) before going into membrane system. The permeate pressure is kept at about 6.9×10⁵ Pa (about 100 psi) making it suitable to be used as a fuel without further compression.

TABLE

| | Feed To | | |
|---|---|---|---|
| | Membrane | Residue | Permeate |
| | Unit | Gas | gas |
| Stream Name | | | |
| Pressure, Pa | 6.97 × 10⁶ | 6.70 × 10⁶ | 5.88 × 10⁵ |
| Temperature, C. | 63 | 60.2 | 61.5 |
| Molar Flow, | 2.0 | 1.7 | 0.3 |
| MMSCFD | | | |
| Composition, | | | |
| Mole Fraction | | | |
| Methane | 0.7193 | 0.6906 | 0.8804 |
| Ethane | 0.1525 | 0.1680 | 0.0657 |
| Propane | 0.0713 | 0.0823 | 0.0094 |
| i-Butane | 0.0092 | 0.0107 | 0.0008 |
| n-Butane | 0.0203 | 0.0236 | 0.0017 |
| i-Pentane | 0.0050 | 0.0058 | 0.0002 |
| n-Pentane | 0.0054 | 0.0063 | 0.0003 |
| n-Hexane+ | 0.0065 | 0.0070 | 0.0002 |
| Nitrogen | 0.0013 | 0.0012 | 0.0019 |
| Carbon dioxide | 0.0086 | 0.0042 | 0.0336 |
| Hydrogen sulfide | 0.0000 | 0.0000 | 0.0000 |
| Water | 0.0011 | 0.0003 | 0.0057 |
| Molecular Weight | 22.7 | 23.5 | 18.4 |
| Lower Heating | 1.31 × 10⁶ J | 1.35 × 10⁶ J | 9.97 × 10⁵ J |
| Value, J/scf | | | |

The feed gas is compressed to about 6.9×10⁶ Pa (about 1000 psi) and then cooled to about 49° C. (about 120° F.) before entering the pretreatment system, upstream of the membrane. The feed gas is passed through a filter coalescer for liquid and mist elimination. A membrane preheater then provides enough superheat to raise the feed gas to the desired operating temperature, depending on the type of membrane employed. The feed subsequently passes through a non-regenerative activated carbon guard bed to remove any lube oil and a particle filter for removal of fine particles after the guard bed.

After pretreatment, the gas enters a single-stage membrane separator system. The membrane separates the gas into a heavier, hydrocarbon rich residue stream and lighter, hydrocarbon rich permeate stream. The residue gas can be sent back to an inter-stage of the compressor to comingle back with the feed gas. CO₂, H₂S, and water permeate fast and will be concentrated in the permeate gas. Moreover, lighter hydrocarbons will also permeate relatively faster compared to heavier hydrocarbons (C₂+ or C₃+), resulting in a residue stream much richer in heavier hydrocarbons. As shown in the Table, the methane concentration in the permeate stream has increased by about 16 percent. The ethane concentration therein has decreased by about 9 percent. The higher carbon number hydrocarbons are also substantially decreased therein, as shown in the Table. As such, using the presently described system, the heating value of the fuel gas has been conditioned for use as a compressor engine fuel gas, that is, the heating value of the fuel gas has been reduced to about 9.97×10⁵ Joules (about 945 BTU), which as noted above is preferable as compared to the unconditioned (about 1.31×10⁶ Joules (about 1238 BTU)) feed gas stream.

Accordingly, methods for conditioning natural gas into fuel gas and membrane separation assemblies used during such methods have been described. The improved membrane separation assemblies beneficially function to condition relatively high heating value natural gas into a relatively lower heating value natural gas, suitable for use as fuel gas for compressor engines.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the processes without departing from the scope defined by the claims, which includes known equivalents and foreseeable equivalents at the time of this disclosure.

What is claimed is:

1. A method for conditioning natural gas into a fuel gas, the method comprising the steps of:
delivering a natural gas stream to a membrane separator, wherein the natural gas stream has a heating value greater than or equal to about 1.15×10⁶ Joules (about 1100 BTU);
separating the natural gas stream in the membrane separator into a residue stream and a permeate stream, wherein the residue stream comprises C₂+ hydrocarbons at a concentration greater than a concentration of C₂+ hydrocarbons in the natural gas stream, and wherein the permeate stream comprises methane at a concentration greater than a concentration of methane in the natural gas stream; and
delivering the permeate stream to an engine for use as fuel gas to the engine.

2. The method of claim 1, wherein delivering a natural gas stream comprises delivering a shale gas stream.

3. The method of claim 1, wherein delivering a natural gas stream comprises delivering a natural gas stream that has a heating value greater than or equal to about 1.35×10⁶ Joules (about 1300 BTU).

4. The method of claim 1, wherein the residue steam comprises C₃+ hydrocarbons at a concentration greater than a concentration of C₃+ hydrocarbons in the natural gas stream.

5. The method of claim 1, further comprising delivering the permeate stream to a compressor engine for use as fuel gas to the compressor engine.

6. The method of claim 1, further comprising compressing the natural gas stream prior to separating the natural gas stream.

7. The method of claim 6, wherein compressing the natural gas stream comprises compressing the natural gas stream to a pressure of about 6.9×10⁶ Pa (about 1000 psi) or greater.

8. The method of claim 1, further comprising passing the natural gas to a filter coalescer after compressing the natural gas.

9. The method of claim 8, further comprising passing the natural gas to a membrane pre-heater after passing the natural gas to the filter coalescer.

10. The method of claim 9, further comprising passing the natural gas to guard bed after passing the natural gas to the membrane pre-heater.

11. The method of claim 10, further comprising passing the natural has to a particle filter after passing the natural gas to the guard bed.

12. The method of claim 1, wherein separating the natural gas further comprises removing one or more of H₂S and H₂O from the natural gas.

13. The method of claim 1, wherein delivering the natural gas stream to the membrane separator comprises delivering the natural gas to a glassy polymer-based membrane separator.

14. The method of claim 13, wherein delivering the natural gas to the glassy polymer-based membrane separator comprises delivering the natural gas to a cellulose acetate membrane separator.

15. The method of claim 13, wherein delivering the natural gas to the glassy polymer-based membrane separator comprises delivering the natural gas to a polyimide, perfluoro polymer-based membrane separator.

16. The method of claim 13, wherein delivering the natural gas to the glassy polymer-based membrane separator comprises delivering the natural gas to a spiral-wound configured membrane separator.

17. The method of claim 13, wherein delivering the natural gas to the glassy polymer-based membrane separator comprises delivering the natural has to a hollow-fiber configured membrane separator.

18. The method of claim 1, wherein the permeate stream that comprises methane at a concentration greater than the concentration of methane in the natural gas stream has a heating value of less than or equal to about 1.05×10⁶ Joules (about 1000 BTU).

19. A method for conditioning natural gas into a fuel gas suitable for use as fuel to a compressor engine, the method comprising the steps of:
compressing a shale natural gas stream to a pressure of about 6.9×10⁶ Pa (about 1000 psi) or greater, wherein the shale natural gas stream has a heating value greater than or equal to about 1.25×10⁶ Joules (about 1200 BTU);
passing the shale natural gas to a filter coalescer after compressing the natural gas;
passing the shale natural gas to a membrane pre-heater after passing the natural gas to the filter coalescer;
passing the shale natural gas to guard bed after passing the natural gas to the membrane pre-heater;
passing the shale natural has to a particle filter after passing the natural gas to the guard bed;
delivering a shale natural gas stream to a glassy polymer cellulose acetate membrane separator;
separating the shale natural gas stream in the membrane separator into a residue stream and a permeate stream, wherein the residue stream comprises C₂+ hydrocarbons at a concentration greater than a concentration of C₂+ hydrocarbons in the shale natural gas stream, and wherein the permeate stream comprises methane at a concentration greater than a concentration of methane in the natural gas stream and has a heating value of less than or equal to about 1.05×10⁶ Joules (about 1000 BTU); and
delivering the permeate stream to a compressor engine for use as fuel gas to the compressor engine.
